(19) United States
(12) Patent Application Publication
(10) Pub. No.: US 2013/0294821 A1
(43) Pub. Date: Nov. 7, 2013

(54) METHOD FOR WELDING RENEWABLE RAW MATERIALS

(71) Applicant: Ulrich Eberle, Filderstadt (DE)

(72) Inventor: Ulrich Eberle, Filderstadt (DE)

(73) Assignee: Maschinenfabrik Gerd Mosca AG, Waldbrunn (DE)

(21) Appl. No.: 13/980,356

(22) PCT Filed: Feb. 3, 2012
(86) PCT No.: PCT/EP2012/051845

§ 371 Date: Jul. 18, 2013

(30) Foreign Application Priority Data
Feb. 4, 2011 (EP) 11153402.0

(51) Int. Cl. B32B 37/04

(52) U.S. Cl. CPC B32B 37/04
USPC 403/270; 156/73.5; 156/73.1; 156/229

(57) ABSTRACT

A method for welding uniaxially oriented renewable raw materials is disclosed. A strap produced according to the method is also disclosed.

The invention relates to a method for welding uniaxially stretched renewable raw materials as well as to a strapping tape which was manufactured using the method according to the invention.

Stretched products made from renewable raw materials, such as tapes for packing purposes, which contain completely biodegradable materials, were developed in the mid-1990s. These tapes mainly contained starch. In principle, these tapes could be welded together. However, due to the poor thermal resistance of starch, these tapes were entirely unsuitable as strapping tapes, since the weld broke under the tensile load usual for strapping tapes. Due to the fact that starch belongs to the polysaccharides, these tapes at the time were not hydrolytically stable and had a low dimensional stability under heat. In addition, a very high concentration of other components, such as polyhydroxybutyrate, is mixed with industrial starch, which creates additional disadvantages. The tapes developed at the time were unusable as strapping tapes (see DE 295 20 448 U1, DE 295 20 449 U1 or EP 0 799 335 B1).

DE 196 54 030 C2 describes a textile cultivation carrier, in which a cable-like, three-dimensional mesh structure made of polyethylene is provided. In column 2, line 35, this polyethylene is described as a typical material of strapping tapes for automatic packing machines. In addition to this material for the mesh structure, the claimed cultivation carrier also has a textile structure which is to be used as a cultivation surface for microorganisms. This textile structure may be made of degradable, organic substances (Column 1, Line 18). Despite the clearly presented technical object, it did not occur to those skilled in the art at the time to also use a degradable, organic material as the material for the cable-like mesh structure. This shows that there was obviously a preconception against using organic, degradable materials for stretched products such as strapping tapes.

DE 699 20 702 T2 describes the ultrasonic welding of products made of poly lactic acid, which are not stretched and therefore do not have to meet any tensile strength requirements.

The object of the invention is therefore to provide a method, by means of which stretched renewable raw materials may be welded in such a way that the resulting products have a high tensile strength.

The object of the invention is achieved in a first specific embodiment by a method for welding uniaxially stretched renewable raw materials, characterized in that
a. surfaces to be welded are at least partially provided from stretched renewable raw material; and
b. the surfaces are welded using heated wedge welding, friction welding, laser welding, high frequency welding or ultrasonic welding.

Up till now, practically no uniaxially stretched products, such as strapping tapes, have been manufactured from renewable raw materials, since the preconception existed that these materials were not mechanically stable enough and/or were, for example, susceptible to hydrolysis. In addition, there was the preconception that a degradation of the material would occur during welding of renewable raw materials, which would cause a deterioration of the mechanical properties. This preconception is all the more true for uniaxially stretched products, since these products are already mechanically prestressed, and the preconception therefore existed that welds or weld seams of stretched products made of renewable raw materials were viewed, for all practical purposes, as predetermined breaking points and, in any case, could not be subjected to a mechanical load. Surprisingly, it has now been discovered that stretched renewable raw materials may be welded by heated wedge welding, friction welding, laser welding and, above all, by ultrasonic welding without the mechanical properties significantly deteriorating.

In step a), a uniaxially stretched tape is preferably used, a uniaxially stretched strapping tape is particularly preferably used, and a uniaxially stretched tape for the packing industry is even more preferably used. Regardless thereof, the material to be welded is preferably stretched at least 1:3. In the case of these materials, in particular, and particularly in the case of strapping tapes, the use thereof usually requires a high tensile strength. Due to the aforementioned preconceptions, strapping tapes made of welded renewable raw materials, in particular, have up to now been believed to be impossible.

In step a), extruded surfaces to be welded are preferably used. In contrast to welding, for example, woven surfaces, a particularly defect-free welding may be implemented without air pockets forming or remaining, for example, at the weld between the surfaces to be welded.

The proportion of renewable raw materials in the surfaces to be welded is preferably independently at least 30 wt. %, in particular at least 50 wt. %, exceptionally preferably at least 90 wt. %. Most preferably, the surfaces to be welded are made of a stretched renewable raw material.

In step a), the renewable raw material is preferably selected from the group of aliphatic polyesters, polyamide, aliphatic polyester amide, polyhydroxyalkanoate, polyvinyl alcohol, polyalkylenglycol, lignin or a copolymer which contains at least one of the compounds, or it is selected from mixtures or derivatives thereof. It is particularly preferred if the renewable raw material is poly lactic acid and/or polybutylene succinate (PMS), or a mixture or a derivative thereof. Stretched products made of renewable raw materials may thus be welded using ultrasound for the first time, which, in contrast to the starch-based materials known up to now, have a particularly high hydrolytic stability and a high dimensional stability under heat.

As a polysaccharide, starch was not only susceptible to hydrolysis but also had the further disadvantage that the package tapes made of starch, for example, thermally degraded during welding, causing the welds to become, so to speak, predetermined breaking points. These disadvantages could be overcome by this preferred specific embodiment. The starch concentration of the surfaces to be welded is therefore also preferably a maximum of 10 wt. %, in particular a maximum of 5 wt. %. Another disadvantage of the starch-based packing tapes known from the prior art was also that industrial starch usually contains over 50 wt. % polyhydroxybutyrate, for example.

The poly lactic acid is preferably made of at least 40 wt. % L-lactic acid, in particular at least 70 wt. % L-lactic acid, exceptionally preferably at least 90 wt. % L-lactic acid. Surprisingly, it has indeed been shown that such a particularly high degree of crystallization may be achieved, so that these tapes may be particularly effectively stretched. Tapes having a higher concentration of D acid appeared to yield an amorphous polymer, which was less suitable for stretching.

The width of the surfaces to be welded is in a range of, for example, 3 mm to 50 mm, in particular in a range of 4 mm to 32 mm. The thickness of the surfaces to be welded is in a range of, for example, 0.2 mm to 2 mm, in particular in a range of 0.4 mm to 1.5 mm.

The weight average of the molar mass M_{W} of the renewable raw material is preferably in a range of 20,000 g/mol to 300,000 g/mol, in particular in a range of 100,000 g/mol to 220,000 g/mol. Such renewable raw materials surprisingly result in strapping tapes which have a particularly balanced ratio between low brittleness and high tensile strength.

Common addition agents, additives and other modifiers may be contained at, for example 0 wt. % to 10 wt. %, in particular 0.5 wt. % to 2 wt. %.

The fiber content of the material of the surfaces is preferably a maximum of 10 wt. %, in particular a maximum of 1 wt. %. The strapping tape according to the invention exceptionally preferably does not contain any fibers. This makes it possible to avoid inhomogeneities in the properties, in particular when processing fibers together with thermoplastic materials, for example due to air pockets.

In step b), a welding time between 5 milliseconds and 1 second, preferably between 100 and 400 milliseconds, is preferably used. Regardless thereof, a cooling time between 0 seconds and 3 seconds, in particular between 0.2 second and 0.5 second, is used in this step b). A combination of the preferred welding time and the preferred cooling time has turned out to be particularly preferred. Otherwise, the welding method is carried out with the usual parameters.

In step b), a sonotrode having the same width as the welding material is advantageously selected for welding. In step b), it is also possible to use a sonotrode for welding, whose length is in the range of 1 mm to 100 mm, in particular 5 mm to 30 mm.

In step b), the surfaces to be welded are advantageously pressed against a counter-plate during welding, the diametrically opposed surfaces of the sonotrode and the counter-plate each having a subsection provided with projections and a smooth subsection. For example, the surface of the sonotrode may be ribbed, while the surface of the counter-plate is smooth. It was surprisingly determined that a less pronounced deformation of the surfaces to be welded in the area of the welded joint occurs as a result. Due to the less pronounced deformation of the surfaces to be welded in the area of the welded joint, in which, for example, tensile force is subsequently applied, the welded joint has a higher strength overall. It was also determined that the strength values have less scatter from one welded joint to another, so that the preferred method according to the invention makes it possible to create a plurality of welded joints having a relatively high and uniform strength.

In another specific embodiment, the object of the invention is achieved by a strapping tape manufactured by a method according to the invention, characterized in that the tear strength is at least 5 N/mm², in particular at least 100 N/mm², measured according to DIN 53504.

The elongation at break according to DIN 53504 is a maximum of 100%, particularly preferably a maximum of 50%, exceptionally preferably a maximum of 20%.

### EXEMPLARY EMBODIMENT

Granulate of poly lactic acid (PLA Polymer 4032D from NatureWorks), which was an L-poly lactic acid, was melted on and extruded through a slot die at 220° C., using a single-screw extruder. The extrudate was placed in a water bath at a temperature of 50° C. and subsequently stretched 1:4 in air. The resulting tape was then fixed in air and cooled and subsequently coiled onto a spool. This resulting strapping tape was then used to strap a common moving box in a test by placing the tape around the moving box so that both ends of the strapping tape overlapped by 2 cm. The overlapping ends of the strapping tape were welded together using ultrasonic welding. The welding time was set to 256 milliseconds. The cooling time was set to 1 second. Otherwise, the parameters were selected as usual. The sonotrode had a width of 4 mm and a length of 15 mm. The surface was ribbed, the width of the ribbing being 1 mm and the depth of the ribbing also being 1 mm. The projections of the ribbing areas were rounded. The counter-plate was smooth. Overall, the manufacturing parameters and, in particular, the thickness and width of the slot die for extrusion, were selected in such a way that a strapping tape having a thickness of 0.7 mm and a width of 12 mm resulted after stretching.

The strapping tape manufactured according to the invention had a tear strength of more than 145 N/mm² (measured according to DIN 53504). The elongation at break was less than 20% (according to DIN 53504). No degradation due to hydrolysis could be observed. The obtained strapping tape was hydrolytically stable. The obtained strapping tape was furthermore dimensionally stable under heat at a temperature of at least 70° C.

The tear strength of the welded joints of the two tapes was greater than 110 N/mm² (according to DIN 53504). The elongation at break was greater than 1% (according to DIN 53504) and less than 20% (according to DIN 53504).

1. A method for welding uniaxially stretched renewable raw materials, comprising:
providing surfaces to be welded that are at least partially provided from a renewable raw material that is stretched; and
welding the surfaces using at least one of: heated wedge welding, friction welding, laser welding, high frequency welding or ultrasonic welding.

2. The method as recited in claim 1, wherein the surfaces are provided from a uniaxially stretched tape.

3. The method as recited in claim 1, wherein the renewable raw material is selected from the group of: aliphatic polyesters, polyamide, aliphatic polyester amide, polyhydroxyalkanoate, polyvinyl alcohol, polyalkylenglycol, lignin or a copolymer which contains at least one of the compounds, or mixtures or derivatives thereof.

4. (canceled)

5. The method as recited in claim 1, wherein a welding time in welding the surfaces is set between 5 milliseconds and 1 second.

6. The method as recited in claim 1, wherein a cooling time in welding the surfaces is set between 0 and 3 seconds.

7. A strapping tape which is welded with itself, comprising:
surfaces welded together that are at least partially provided from a renewable raw material that is stretched, wherein the welded surfaces have a tear strength that is at least 5 N/mm², measured according to DIN 53540.

8. The strapping tape as recited in claim 7, wherein the surfaces are provided from a uniaxially stretched tape.

9. The strapping tape as recited in claim 7, wherein the renewable raw material is selected from the group of: aliphatic polyesters, polyamide, aliphatic polyester amide, polyhydroxyalkanoate, polyvinyl alcohol, polyalkylenglycol, lignin or a copolymer which contains at least one of the compounds, or mixtures or derivatives thereof.

10. The strapping tape as recited in claim 9, wherein the renewable raw material is a poly lactic acid or a polybutylene succinate or a mixture or a derivative thereof.

11. The strapping tape as recited in claim 10, wherein the poly lactic acid is made at least of 40 wt. % L-lactic acid.

12. The strapping tape as recited in claim 11, wherein the poly lactic acid is made at least of 90 wt. % L-lactic acid.

13. The method as recited in claim 2, wherein the uniaxially stretched tape is a uniaxially stretched strapping tape.

14. The method as recited in claim 3, wherein the renewable raw material is a poly lactic acid or a polybutylene succinate or a mixture or a derivative thereof.

15. The method as recited in claim 14, wherein the poly lactic acid is made at least of 40 wt. % L-lactic acid.

16. The method as recited in claim 15, wherein the poly lactic acid is made at least of 90 wt. % L-lactic acid.
